(19) United States
(12) Patent Application Publication
(10) Pub. No.: US 2025/0001507 A1
(43) Pub. Date: Jan. 2, 2025

(54) CUTTING INSERT, CUTTING TOOL, AND METHOD FOR MANUFACTURING MACHINED PRODUCT

(71) Applicant: KYOCERA CORPORATION, Kyoto (JP)

(72) Inventors: Akira YOSHIDA, Kyoto (JP); Yoshiki IWASHITA, Kyoto (JP)

(21) Appl. No.: 18/710,614

(22) PCT Filed: Nov. 10, 2022
(86) PCT No.: PCT/JP2022/041893

§ 371 Date: May 16, 2024

(30) Foreign Application Priority Data
Nov. 17, 2021 (JP) 2021-187312

(51) Int. Cl. B23B 27/16; B23B 1/00

(52) U.S. Cl. CPC B23B 27/1611; B23B 1/00

(57) ABSTRACT

The cutting insert includes an upper surface, a front side surface, a first corner side surface, a front cutting edge, and a first corner cutting edge. The upper surface includes a front land surface extending along the front cutting edge, a first corner land surface extending along the first corner cutting edge, a front groove extending inwardly with respect to the front land surface, and a first corner groove extending inwardly with respect to the first corner land surface. The length of the first corner groove is shorter than the length of the front groove.

### CROSS-REFERENCE TO RELATED APPLICATIONS

This application is national stage application of International Application No. PCT/JP2022/041893, filed on Nov. 10, 2022, which claims priority to Japanese Patent Application No. 2021-187312, filed on Nov. 17, 2021.

### TECHNICAL FIELD

The present disclosure relates to a cutting insert used in machining for a workpiece, a cutting tool, and a method for manufacturing a machined product.

### BACKGROUND OF INVENTION

As cutting inserts used for machining a workpiece, cutting inserts disclosed in Patent Documents 1 and 2 may be exemplified. Usually, during machining, a coolant (cooling solvent) is injected toward a cutting insert to remove chips and cool the cutting insert. In order to enhance the cooling effect of the coolant on a cutting edge, the cutting inserts disclosed in Patent Documents 1 and 2 are provided with grooves.

### CITATION LIST

### Patent Literature

Patent Document 1: JP 2014-018891 A
Patent Document 2: JP 2002-502711 A

### SUMMARY

A cutting insert according to the present disclosure includes an upper surface having a first corner, a second corner, and a first side connected to the first corner and the second corner. The cutting insert according to the present disclosure includes a front side surface connected to the first side, a first corner side surface connected to the first corner, a front cutting edge located on the first side, and a first corner cutting edge located on the first corner. The upper surface further includes a front land surface located at an outer edge of the upper surface and extending along the front cutting edge, a first corner land surface located at an outer edge of the upper surface and extending along the first corner cutting edge, a front groove extending inward with respect to the front land surface, and a first corner groove extending inward with respect to the first corner land surface. A length of the first corner groove is shorter than a length of the front groove.

### BRIEF DESCRIPTION OF THE DRAWINGS

FIG. 1 is a schematic perspective view of a cutting tool according to an embodiment of the present disclosure.

FIG. 2 is an enlarged view of portion II in FIG. 1.

FIG. 3 is a schematic perspective view of a cutting insert according to the embodiment of the present disclosure.

FIG. 4 is schematic top view of the cutting insert illustrated in FIG. 3.

FIG. 5 is schematic right side view of the cutting insert illustrated in FIG. 3.

FIG. 6 is schematic left side view of the cutting insert illustrated in FIG. 3.

FIG. 7 is schematic front view of the cutting insert illustrated in FIG. 3.

FIG. 8 is an enlarged view of portion VIII in FIG. 3 and is a schematic enlarged perspective view of a part of the cutting insert according to the embodiment of the present disclosure.

FIG. 9 is a schematic enlarged top view of a part of the cutting insert according to the embodiment of the present disclosure.

FIG. 10 is a schematic enlarged perspective view of a part of a cutting insert according to a first variation of the embodiment of the present disclosure.

FIG. 11 is a schematic enlarged perspective view of a part of a cutting insert according to a second variation of the embodiment of the present disclosure.

FIG. 12 is a schematic enlarged perspective view of a part of a cutting insert according to a third variation of the embodiment of the present disclosure.

FIG. 13 is a schematic enlarged perspective view of a part of a cutting insert according to a fourth variation of the embodiment of the present disclosure.

FIG. 14 is a schematic view illustrating a method for manufacturing a machined product according to an embodiment of the present disclosure.

FIG. 15 is a schematic view illustrating the method for manufacturing the machined product according to the embodiment of the present disclosure.

FIG. 16 is a schematic view illustrating the method for manufacturing the machined product according to the embodiment of the present disclosure.

### DESCRIPTION OF EMBODIMENTS

In the cutting inserts disclosed in Patent Documents 1 and 2, although the cooling effect of the coolant on the cutting edge is enhanced by providing the grooves, the durability of the cutting insert may be decreased. That is, a good cooling effect and an improvement in durability of the cutting insert are required to be compatible.

According to the present disclosure, the durability of the cutting insert can be improved while enhancing the cooling effect of the coolant on the cutting edge.

A cutting insert, a cutting tool, and a method for manufacturing a machined product according to an embodiment of the present disclosure will be described below in detail with reference to the drawings. However, each of the figures, which will be referred to below, is a simplified representation of only components necessary for description of the embodiments, for convenience of description. Accordingly, the cutting insert according to an embodiment of the present disclosure may be provided with an optional component that is not illustrated in the referenced figures. The dimensions of the components in the drawings do not faithfully represent the actual dimensions of the components, the dimension ratios of the members, or the like. In the present disclosure, “parallel” is not limited to “strictly parallel” but means that an error of about +5 degrees is allowed.

### Cutting Tool

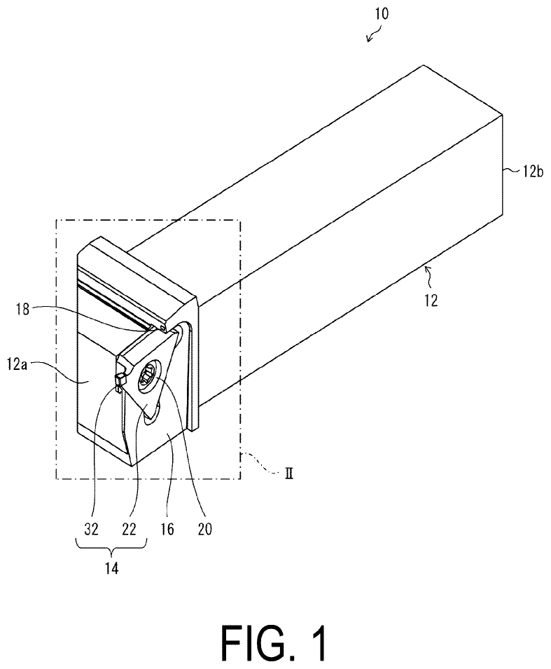

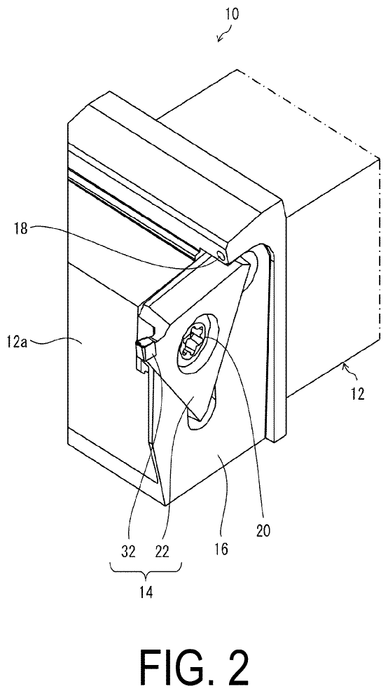

A cutting tool 10 according to the embodiment of the present disclosure will be described with reference to FIGS. 1 and 2. FIG. 1 is a schematic perspective view of the cutting tool 10 according to the embodiment of the present disclosure. FIG. 2 is an enlarged view of portion II in FIG. 1.

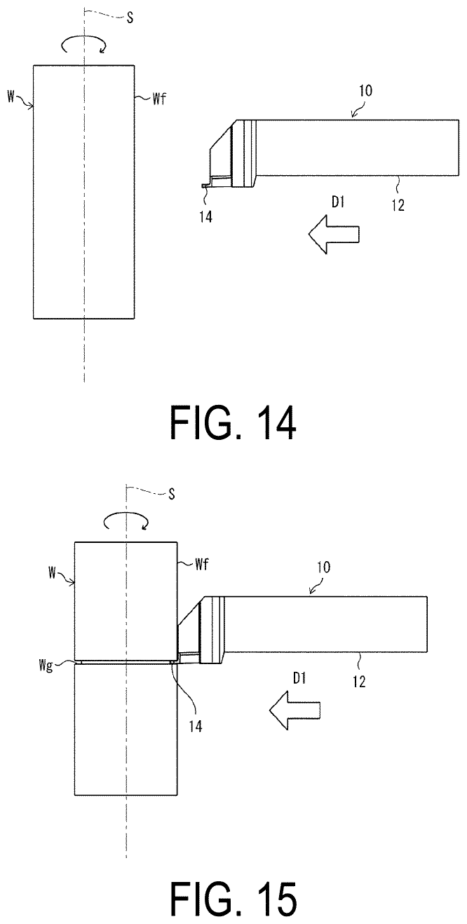

As the example illustrated in FIGS. 1 to 2, the cutting tool 10 according to the embodiment of the present disclosure is a turning tool used for turning among the machining of a workpiece W (see FIG. 14). The machining of the workpiece W includes external turning, boring, groove-forming, cutting-off, and the like. The cutting tool 10 may include: a holder 12 attached to a tool rest of a lathe; and a cutting insert 14 held by the holder 12.

The holder 12 may have a square rod shape extending from a front end 12a as a first end to a rear end 12b as a second end. The holder 12 may have a rod shape other than a square rod shape, such as a round rod shape. Examples of the material of the holder 12 include metals such as stainless steel, carbon steel, cast iron, an aluminum alloy, or the like. The holder 12 may have a pocket 16 for holding the cutting insert 14 and the pocket 16 may be located proximate to the front end 12a. The length of the holder 12 may be set to, for example, from 100 mm to 400 mm.

The holder 12 may have an injection port 18 for injecting coolant (cooling medium) toward the cutting insert 14 and the injection port 18 may be provided proximate to the front end 12a. The coolant is, for example, made from a water-insoluble or a water-soluble oil, and can be suitably selected and used according to the material of the workpiece W. Examples of the water-insoluble oil include an oil-based type, an inactive extreme-pressure type, and an active extreme-pressure type cutting oil. Examples of the water-soluble oil include a cutting oil such as an emulsion, a soluble, and a solution. The coolant is not limited to a liquid, and may be a gas such as an inert gas.

The cutting insert 14 may be located in the pocket 16 of the holder 12. The cutting insert 14 may be fixed to the pocket 16 of the holder 12 by a fixing screw 20. The cutting insert 14 may be fixed to the pocket 16 of the holder 12 by a clamp member instead of the fixing screw 20.

### Cutting Insert

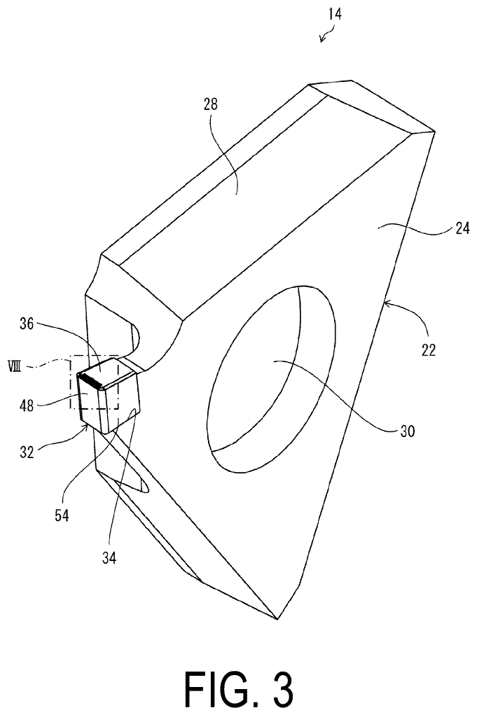

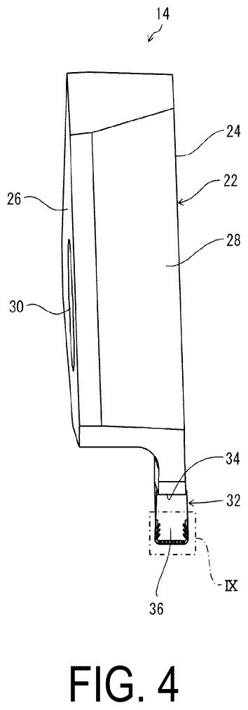

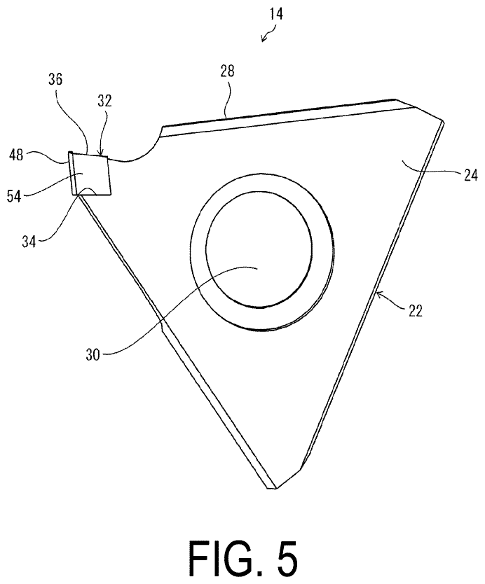

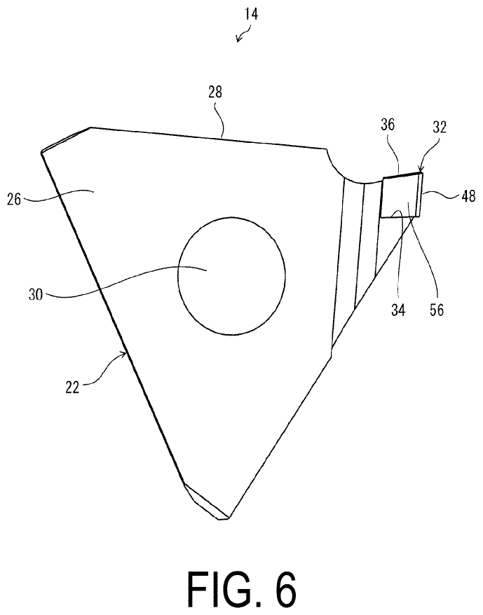

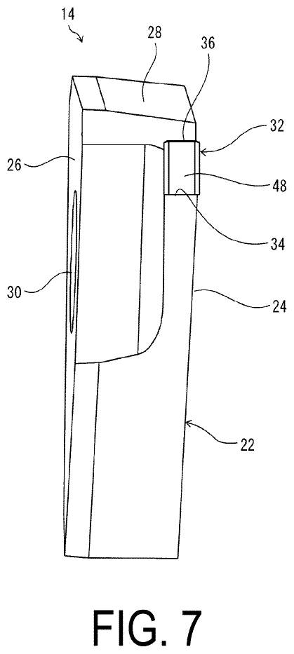

A configuration of the cutting insert 14 according to the embodiment of the present disclosure will be described with reference to FIGS. 3 to 7. FIG. 3 is a schematic perspective view of the cutting insert 14 according to the embodiment of the present disclosure. FIG. 4 is a schematic top view of the cutting insert 14 illustrated in FIG. 3. FIG. 5 is schematic right side view of the cutting insert 14 illustrated in FIG. 3. FIG. 6 is schematic left side view of the cutting insert 14 illustrated in FIG. 3. FIG. 7 is schematic front view of the cutting insert 14 illustrated in FIG. 3.

As in the examples illustrated in FIGS. 3 to 7, the cutting insert 14 according to the embodiment of the present disclosure may include a base portion 22 for mounting the cutting insert 14 in the pocket 16 of the holder 12. The base portion 22 may include: a first main surface 24 having a substantially polygonal shape such as a substantially triangular shape; and a second main surface 26 located on an opposite side of the first main surface 24. Each of the first main surface 24 and the second main surface 26 may have a substantially polygonal shape such as a substantially triangular shape. In other words, the base portion 22 may have a substantially polygonal plate shape such as a substantially triangular plate shape.

The base portion 22 may have a plurality of side surfaces located between the first main surface 24 and the second main surface 26, and any one of the plurality of side surfaces may be a flat base upper surface 28. The base portion 22 may include a through hole 30 through which the fixing screw 20 is inserted at a central portion thereof. The through hole 30 may open on the first main surface 24 and the second main surface 26.

The cutting insert 14 according to the embodiment of the present disclosure may include a cutting portion 32 that comes into contact with the workpiece W to perform machining. The cutting portion 32 may be provided only at one corner portion of a plurality of corner portions of the base portion 22. The cutting portion 32 may be provided at each of the plurality of corner portions of the base portion 22. The cutting portion 32 may be provided at a notch portion 34 provided at a corner portion of the base portion 22.

Examples of a material of the base portion 22 include cemented carbide alloy or cermet. Examples of the composition of the cemented carbide alloy include WC—Co, WC—TiC—Co, and WC—TiC—TaC—Co. WC—Co is produced by adding a cobalt (Co) powder to tungsten carbide (WC) and sintering this mixture. WC—TiC—Co is formed by adding titanium carbide (TiC) to WC—Co. WC—TiC—TaC—Co is formed by adding tantalum carbide (TaC) to WC—TiC—Co. Cermet is a sintered composite material in which a metal is combined with a ceramic component. Specifically, examples of the cermet include compounds in which a titanium compound such as titanium carbide (TiC) and titanium nitride (TiN) is the primary component.

Examples of a material of the cutting portion 32 include hard materials such as cubic boron nitride (cBN), and polycrystalline diamond (PCD). When the material of the cutting portion 32 is different from the material of the base portion 22, the cutting portion 32 may be joined to the base portion 22 by a brazing material. When the material of the cutting portion 32 is the same as the material of the base portion 22, the cutting portion 32 may be integrally formed with the base portion 22.

The surface of the cutting insert 14 may be coated with a coating film using a chemical vapor deposition (CVD) method or a physical vapor deposition (PVD) method. Examples of a material of the coating film include titanium carbide (TIC), titanium nitride (TiN), titanium carbonitride (TiCN), or alumina (Al₂O₃).

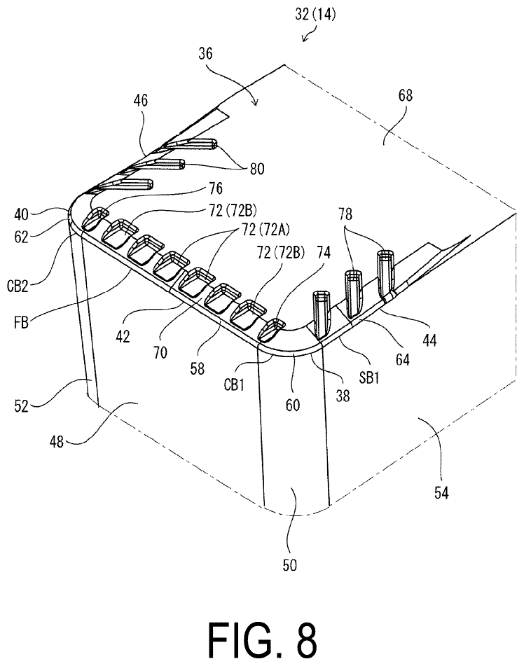

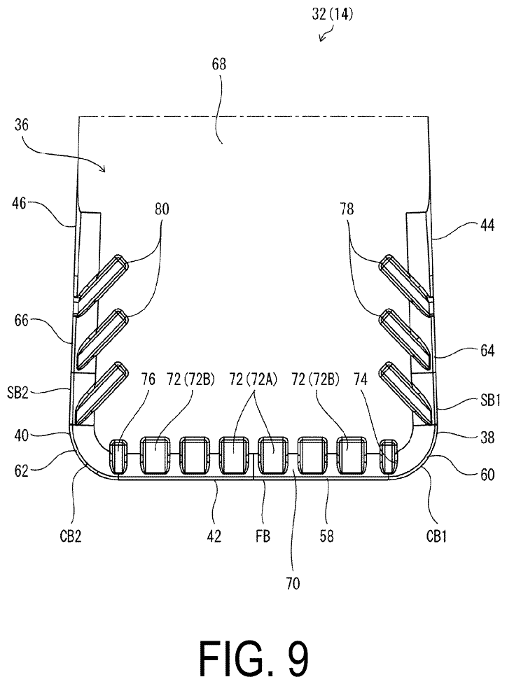

A specific configuration of the cutting portion 32 of the cutting insert 14 according to the embodiment of the present disclosure will be described with reference to FIGS. 8 to 9. FIG. 8 is an enlarged view of portion VIII in FIG. 3 and is a schematic enlarged perspective view of a part of the cutting insert 14 according to the embodiment of the present disclosure. FIG. 9 is a schematic enlarged top view of a part of the cutting insert 14 according to the embodiment of the present disclosure.

As in the example illustrated in FIGS. 8 and 9, the cutting portion 32 of the cutting insert 14 may include an upper surface 36, and the upper surface 36 may function as a rake surface for chip flow. The upper surface 36 of the cutting portion 32 may constitute an upper surface of the cutting insert 14 together with the base upper surface 28 of the base portion 22.

The upper surface 36 of the cutting portion 32 may include a first corner 38, a second corner 40, and a first side 42 connected to the first corner 38 and the second corner 40. The first corner 38 and the second corner 40 may each have a curved shape. The first side 42 may be linear or may be slightly curved. Note that the first side 42 being slightly curved means that the first side 42 is not limited to a strictly linear shape. Therefore, the radius of curvature of the first side 42 when the first side 42 is slightly curved is ten times or more the radius of curvature of each of the first corner 38 and the second corner 40, and the first side 42 may be macroscopically regarded as linear as compared with the first corner 38 and the second corner 40. The upper surface 36 of the cutting portion 32 may include: a second side 44 connected to the first corner 38; and a third side 46 connected to the second corner 40. The second side 44 and the third side 46 may be parallel to each other. Alternatively, the second side 44 and the third side 46 may gradually approach each other as they are away from the first side 42.

The cutting portion 32 may include a front side surface 48 connected to the first side 42, and the front side surface 48 may function as a flank face. The cutting portion 32 may include: a first corner side surface 50 connected to the front side surface 48 and the first corner 38; and a second corner side surface 52 connected to the front side surface 48 and the second corner. Each of the first corner side surface 50 and the second corner side surface 52 may have a function as a flank face. The first corner side surface 50 and the second corner side surface 52 may each have a width that decreases with increasing distance from the upper surface 36. The cutting portion 32 may include: a first lateral side surface 54 connected to the first corner side surface 50 and the second side 44; and a second lateral side surface 56 connected to the second corner side surface 52 and the third side 46. Each of the first lateral side surface 54 and the second lateral side surface 56 may function as a flank face.

The cutting portion 32 may include a front cutting edge FB located on the first side 42 where the upper surface 36 and the front side surface 48 intersect. The front cutting edge FB may be located in the entire region or a partial region of the first side 42. The cutting portion 32 may include a first corner cutting edge CB1 located at the first corner 38 where the upper surface 36 and the first corner side surface 50 intersect. The first corner cutting edge CB1 may be located in the entire region or a partial region of the first corner 38. The cutting portion 32 may include a second corner cutting edge CB2 located at the second corner 40 where the upper surface 36 and the second corner side surface 52 intersect. The second corner cutting edge CB2 may be located in the entire region or a partial region of the second corner 40.

The cutting portion 32 may include a first lateral cutting edge SB1 located on the second side 44 where the upper surface 36 and the first lateral side surface 54 intersect. The first lateral cutting edge SB1 may be located in the entire region or a partial region of the second side 44. The first lateral cutting edge SB1 may have a function of finishing the machined surface of the workpiece W. The first lateral cutting edge SB1 may be omitted from the cutting portion 32 to avoid interference between the second side 44 and the machined surface of the workpiece W. The cutting portion 32 may include a second lateral cutting edge SB2 located on the third side 46 where the upper surface 36 and the second lateral side surface 56 intersect. The second lateral cutting edge SB2 may be located in the entire region or a partial region of the third side 46. The second lateral cutting edge SB2 may have a function of finishing the machined surface of the workpiece W. The second lateral cutting edge SB2 may be omitted from the cutting portion 32 to avoid interference between the third side 46 and the machined surface of the workpiece W.

The upper surface 36 of the cutting portion 32 may have a front land surface 58 for enhancing the strength of the front cutting edge FB. The front land surface 58 may be located at an outer edge of the upper surface 36 of the cutting portion 32 and extend along the front cutting edge FB. The front land surface 58 may be connected to the front cutting edge FB. The upper surface 36 of the cutting portion 32 may include a first corner land surface 60 for enhancing the strength of the first corner cutting edge CB1. The first corner land surface 60 may be located at an outer edge of the upper surface 36 of the cutting portion 32 and extend along the first corner cutting edge CB1. The first corner land surface 60 may be connected to the first corner cutting edge CB1. The upper surface 36 of the cutting portion 32 may include a second corner land surface 62 for enhancing the strength of the second corner cutting edge CB2. The second corner land surface 62 may be located at an outer edge of the upper surface 36 of the cutting portion 32 and extend along the second corner cutting edge CB2. The second corner land surface 62 may be connected to the second corner cutting edge CB2.

The upper surface 36 of the cutting portion 32 may include a first lateral land surface 64 to enhance the strength of the first lateral cutting edge SB1. The first lateral land surface 64 may be located at an outer edge of the upper surface 36 of the cutting portion 32 and extend along the first lateral cutting edge SB1. The first lateral land surface 64 may be connected to the first lateral cutting edge SB1. The upper surface 36 of the cutting portion 32 may include a second lateral land surface 66 for enhancing the strength of the second lateral cutting edge SB2. The second lateral land surface 66 may be located at an outer edge of the upper surface 36 of the cutting portion 32 and extend along the second lateral cutting edge SB2. The second lateral land surface 66 may be connected to the second lateral cutting edge SB2.

Each of the front land surface 58, the first corner land surface 60, the second corner land surface 62, the first lateral land surface 64, and the second lateral land surface 66 may be set as, for example, a band-shaped region having a width of approximately from 0.03 mm to 0.5 mm in a top surface view.

The upper surface 36 of the cutting portion 32 may have a flat upper end surface 68 located on the base portion 22 side. The upper surface 36 of the cutting portion 32 may include a rising wall surface 70 located between an outer edge of the upper surface 36 and the upper end surface 68. The rising wall surface 70 may be inclined with respect to the upper end surface 68, and may have a function of curling chips to improve chip dischargeability.

The upper surface 36 of the cutting portion 32 may include a front groove 72 extending inwardly with respect to the front land surface 58 toward the center of the upper surface 36. The front groove 72 may have a function as a coolant reservoir (gap) for storing the coolant. The front groove 72 may be separated from the front land surface 58 and the front cutting edge FB. The front groove 72 may be connected to the front land surface 58 instead of being separated from the front land surface 58.

The front groove 72 may be connected to the rising wall surface 70. The front groove 72 may be connected to the upper end surface 68. Chips are likely to come into contact with the rising wall surface 70, whereas chips are unlikely to come into contact with the upper end surface 68. Therefore, when the front groove 72 is connected to the upper end surface 68, the coolant easily flows into the front groove 72 from the upper end surface 68. As a result, the coolant is easily accumulated in the front groove 72.

In the example of FIGS. 8 and 9, the number of the front grooves 72 is plural, but may be one. When there is a plurality of front grooves 72, the plurality of front grooves 72 may include: a first front groove 72A; and a second front groove 72B located closer to the first corner 38 than the first front groove 72A. The length of the first front groove 72A may be the same as the length of the second front groove 72B.

The upper surface 36 of the cutting portion 32 may include a first corner groove 74 extending inwardly with respect to the first corner land surface 60. The first corner groove 74 may have a function as a coolant reservoir for storing the coolant. The first corner groove 74 may be separated from the first corner land surface 60 and the first corner cutting edge CB1. The first corner groove 74 may be connected to the first corner land surface 60 instead of being separated from the first corner land surface 60.

The first corner groove 74 may be connected to the rising wall surface 70. The first corner groove 74 may be connected to the upper end surface 68. When the first corner groove 74 is connected to the upper end surface 68, the coolant easily flows into the first corner groove 74 from the upper end surface 68. As a result, the coolant is easily accumulated in the first corner groove 74. In the example of FIGS. 8 and 9, the number of the first corner grooves 74 is one, but may be plural.

The first corner groove 74 may extend inwardly with respect to the boundary between the front land surface 58 and the first corner land surface 60. The first corner groove 74 is separated from the boundary between the front land surface 58 and the first corner land surface 60, but may be connected to the boundary. The first corner groove 74 may extend parallel to the front groove 72. The length of the first corner groove 74 may be shorter than the length of the front groove 72. The width of the first corner groove 74 may be smaller than the width of the front groove 72. The depth of the first corner groove 74 may be the same as the depth of the front groove 72.

The upper surface 36 of the cutting portion 32 may include a second corner groove 76 extending inwardly with respect to the second corner land surface 62. The second corner groove 76 may function as a coolant reservoir. The second corner groove 76 may be separated from the second corner land surface 62 and the second corner cutting edge CB2. The second corner groove 76 may be connected to the second corner land surface 62 instead of being separated from the second corner land surface 62.

The second corner groove 76 may be connected to the rising wall surface 70. The second corner groove 76 may be connected to the upper end surface 68. When the second corner groove 76 is connected to the upper end surface 68, the coolant easily flows into the second corner groove 76 from the upper end surface 68. As a result, the coolant is easily accumulated in the second corner groove 76. In the example of FIGS. 8 and 9, the number of the second corner grooves 76 is one, but may be plural.

The second corner groove 76 may extend inwardly with respect to the boundary between the front land surface 58 and the second corner land surface 62. The second corner groove 76 is separated from the boundary between the front land surface 58 and the second corner land surface 62, but may be connected to the boundary. The second corner groove 76 may extend parallel to the front groove 72. The length of the second corner groove 76 may be shorter than the length of the front groove 72. The width of the second corner groove 76 may be smaller than the width of the front groove 72. The depth of the second corner groove 76 may be the same as the depth of the front groove 72.

The upper surface 36 of the cutting portion 32 may include a first lateral groove 78 extending inwardly with respect to the first lateral land surface 64. The first lateral groove 78 may have a function as a coolant reservoir. The first lateral groove 78 may be separated from the first lateral land surface 64 and the first lateral cutting edge SB1. The first lateral groove 78 may be connected to the first lateral land surface 64.

The first lateral groove 78 may be connected to the rising wall surface 70. The first lateral groove 78 may be connected to the upper end surface 68. When the first lateral groove 78 is connected to the upper end surface 68, the coolant easily flows into the first lateral groove 78 from the upper end surface 68. As a result, the coolant is easily accumulated in the first lateral groove 78. The length of the first lateral groove 78 may be longer than the length of the first corner groove 74. In the example of FIGS. 8 and 9, the number of the first lateral grooves 78 is plural, but may be one.

The upper surface 36 of the cutting portion 32 may include a second lateral groove 80 extending inwardly with respect to the second lateral land surface 66. The second lateral groove 80 may have a function as a coolant reservoir. The second lateral groove 80 may be separated from the second lateral land surface 66 and the second lateral cutting edge SB2. The second lateral groove 80 may be connected to the second lateral land surface 66.

The second lateral groove 80 may be connected to the rising wall surface 70. The second lateral groove 80 may be connected to the upper end surface 68. When the second lateral groove 80 is connected to the upper end surface 68, the coolant easily flows into the second lateral groove 80 from the upper end surface 68. As a result, the coolant is easily accumulated in the second lateral groove 80. The length of the second lateral groove 80 may be longer than the length of the second corner groove 76. In the examples of FIGS. 8 and 9, the number of the second lateral grooves 80 is plural, but may be one.

Each of the front groove 72, the first corner groove 74, the second corner groove 76, the first lateral groove 78, and the second lateral groove 80 may have a V-shaped cross section or a rectangular cross section in the width direction. The lengths of the front groove 72, the first corner groove 74, the second corner groove 76, the first lateral groove 78, and the second lateral groove 80 may be set to from 0.3 mm to 3 mm, for example. The widths of the front groove 72, the first corner groove 74, the second corner groove 76, the first lateral groove 78, and the second lateral groove 80 may be set to from 0.05 mm to 0.5 mm, for example. The depths of the front groove 72, the first corner groove 74, the second corner groove 76, the first lateral groove 78, and the second lateral groove 80 may be set to from 0.05 mm to 0.5 mm, for example.

When the upper surface 36 of the cutting portion 32 include the front groove 72 and the first corner groove 74 as in the example illustrated in FIGS. 3 to 8, the coolant can be efficiently supplied to the front cutting edge FB and the first corner cutting edge CB1. Thus, the cooling effect of the coolant on the front cutting edge FB and the first corner cutting edge CB1 can be enhanced.

A larger cutting load is applied to the first corner cutting edge CB1 than to the front cutting edge FB. And thus, when the first corner groove 74 has the same shape (the same width and the same length) as the front groove 72, cracks are likely to occur in the first corner cutting edge CB1. On the other hand, when the length of the first corner groove 74 is shorter than the length of the front groove 72 as in the example illustrated in FIGS. 3 to 8, the strength of the first corner cutting edge CB1 is enhanced, and cracks are less likely to occur in the first corner cutting edge CB1.

That is, according to the example illustrated in FIGS. 3 to 8, the durability of the first corner cutting edge CB1, in other words, the durability of the cutting insert 14 can be improved while enhancing the cooling effect of the coolant on the front cutting edge FB and the first corner cutting edge CB1.

When the width of the first corner groove 74 is smaller than the width of the front groove 72 as in the example illustrated in FIGS. 3 to 8, the strength of the first corner cutting edge CB1 is further enhanced, and cracks are more unlikely to occur in the first corner cutting edge CB1. Thus, the durability of the cutting insert 14 can be further improved.

When the depth of the first corner groove 74 is the same as the depth of the front groove 72 as in the example illustrated in FIGS. 3 to 8, a sufficient amount of coolant can be reserved in the first corner groove 74. Thus, the cooling effect of the coolant on the first corner cutting edge CB1 can be further enhanced. When the depths of the front groove 72 and the first corner groove 74 are not constant, the maximum value of the depth of the front groove 72 and the maximum value of the depth of the first corner groove 74 may be compared. Note that the depth of the first corner groove 74 being the same as the depth of the front groove 72 does not require that they are the same in a strict sense. When the depth of the first corner groove 74 is about from 97% to 103% of the depth of the front groove 72, it may be considered to be the same.

The front cutting edge BF or the first corner cutting edge CB1 has been found to be likely to deteriorate in the vicinity of the boundary between the first side 42 and the first corner 38 on the upper surface 36 of the cutting portion 32. As in the example illustrated in FIGS. 3 to 8, when the first corner groove 74 extends inwardly with respect to the boundary between the front land surface 58 and the first corner land surface 60, the coolant can be efficiently supplied to the boundary. As a result, in the vicinity of the boundary between the first side 42 and the first corner 38 on the upper surface 36 of the cutting portion 32, the front cutting edge BF or the first corner cutting edge CB1 is less likely to deteriorate, and the durability of the cutting insert 14 can be further improved. In particular, when the first corner groove 74 extends parallel to the front groove 72, a local decrease in the distance between the first corner groove 74 and the front groove 72 can be suppressed, thereby further improving the durability of the cutting insert 14.

As in the example illustrated in FIGS. 3 to 8, when the length of the first front groove 72A is the same as the length of the second front groove 72B, the variation in the coolant supplied to the entire region of the front cutting edge FB can be reduced. Thus, the durability of the first corner cutting edge CB1, in other words, the durability of the cutting insert 14 can be further improved.

As in the example illustrated in FIGS. 3 to 8, when the length of the second corner groove 76 is shorter than the length of the front groove 72, the strength of the second corner cutting edge CB2 is enhanced, and cracks are less likely to occur in the second corner cutting edge CB2. As a result, the durability of the second corner cutting edge CB2 can be further improved.

As in the example illustrated in FIGS. 3 to 8, when the length of the first lateral groove 78 is longer than the length of the first corner groove 74, a sufficient amount of coolant can be reserved in the first lateral groove 78. Thus, the cooling effect of the coolant on the first lateral cutting edge SB1 can be further enhanced.

### First Variation of Embodiment

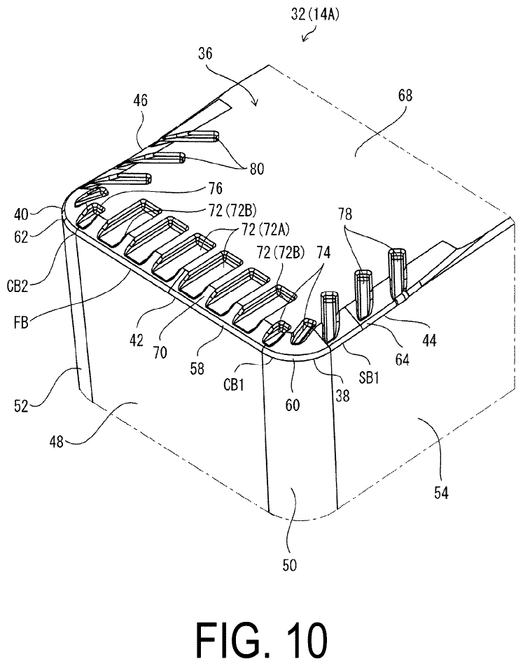

A configuration of a cutting insert 14A according to a first variation of the embodiment of the present disclosure will be described with reference to FIG. 10. FIG. 10 is a schematic enlarged perspective view of a part of the cutting insert 14A according to the first variation of the embodiment of the present disclosure.

As in the example illustrated in FIG. 10, the cutting insert 14A according to the first variation of the embodiment of the present disclosure has the same configuration as that of the cutting insert 14 except for some parts. In the configuration of the cutting insert 14A, differences from the configuration of the cutting insert 14 will be described. For convenience of description, a member having the same function as that of a member described in the embodiment is denoted by the same reference sign.

The upper surface 36 of the cutting portion 32 may have two first corner grooves 74 extending inwardly with respect to the first corner land surface 60. One of the first corner grooves 74 may extend inwardly with respect to the boundary between the front land surface 58 and the first corner land surface 60. The other first corner groove 74 may extend inwardly with respect to the center portion of the first corner land surface 60.

The upper surface 36 of the cutting portion 32 may include two second corner grooves 76 extending inwardly with respect to the second corner land surface 62. One of the second corner grooves 76 may extend inwardly with respect to the boundary between the front land surface 58 and the second corner land surface 62. The other second corner groove 76 may extend inwardly with respect to the center portion of the second corner land surface 62.

When the upper surface 36 of the cutting portion 32 has two first corner grooves 74 as in the example illustrated in FIG. 10, the sufficient coolant can be supplied to the first corner cutting edge CB1 to enhance the cooling effect of the coolant on the first corner cutting edge CB1.

### Second Variation of Embodiment

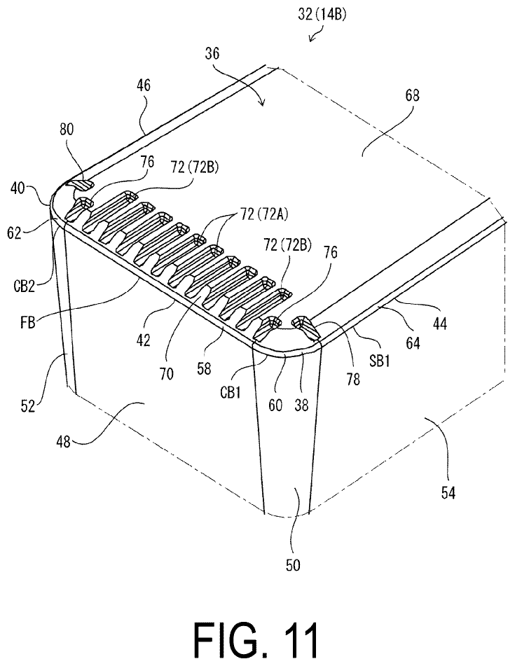

A configuration of a cutting insert 14B according to a second variation of the embodiment of the present disclosure will be described with reference to FIG. 11. FIG. 11 is a schematic enlarged perspective view of a part of the cutting insert 14B according to the second variation of the embodiment of the present disclosure.

As in the example illustrated in FIG. 11, the cutting insert 14B according to the second variation of the embodiment of the present disclosure has the same configuration as that of the cutting insert 14 except for some parts. In the configuration of the cutting insert 14B, differences from the configuration of the cutting insert 14 will be described. For convenience of description, a member having the same function as that of a member described in the embodiment is denoted by the same reference sign.

The upper surface 36 of the cutting portion 32 may include one first lateral groove 78 extending inwardly with respect to the first lateral land surface 64. The first lateral groove 78 may extend inwardly with respect to the boundary between the first lateral land surface 64 and the first corner land surface 60.

The upper surface 36 of the cutting portion 32 may include one second lateral groove 80 extending inwardly with respect to the second lateral land surface 66. The second lateral groove 80 may extend inwardly with respect to the boundary between the second lateral land surface 66 and the first corner land surface 60.

The first corner side surface 50 and the second corner side surface 52 may each have a width that becomes smaller with increasing distance from the upper surface 36.

As in the example illustrated in FIG. 11, when the first lateral groove 78 extends inwardly with respect to the boundary between the first lateral land surface 64 and the first corner land surface 60, the coolant can be efficiently supplied to the boundary. As a result, in the vicinity of the boundary between the second side 44 and the first corner 38 on the upper surface 36 of the cutting portion 32, the first lateral cutting edge CF or the first corner cutting edge CB1 is less likely to deteriorate, and the durability of the cutting insert 14 can be further improved.

### Third Variation of Embodiment

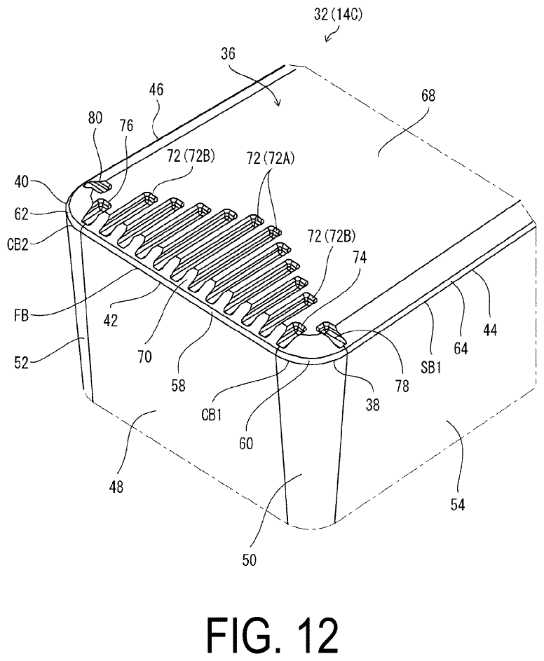

A configuration of a cutting insert 14C according to a third variation of the embodiment of the present disclosure will be described with reference to FIG. 12. FIG. 12 is a schematic enlarged perspective view of a part of the cutting insert 14C according to the third variation of the embodiment of the present disclosure.

As in the example illustrated in FIG. 12, the cutting insert 14C according to the third variation of the embodiment of the present disclosure has the same configuration as that of the cutting insert 14B except for some parts. In the configuration of the cutting insert 14C, differences from the configuration of the cutting insert 14B will be described. For convenience of description, a member having the same function as that of a member described in the second variation of the embodiment is denoted by the same reference sign.

The plurality of front grooves 72 may include: the first front groove 72A; and the second front groove 72B located closer to the first corner 38 than the first front groove 72A. The length of the first front groove 72A may be longer than the length of the second front groove 72B.

As in the example illustrated in FIG. 12, when the length of the first front groove 72A is longer than the length of the second front groove 72B, the coolant can be efficiently supplied to the center portion of the front cutting edge bF where heat dissipation is difficult. Thus, the cooling effect of the coolant on the front cutting edge FB can be further enhanced.

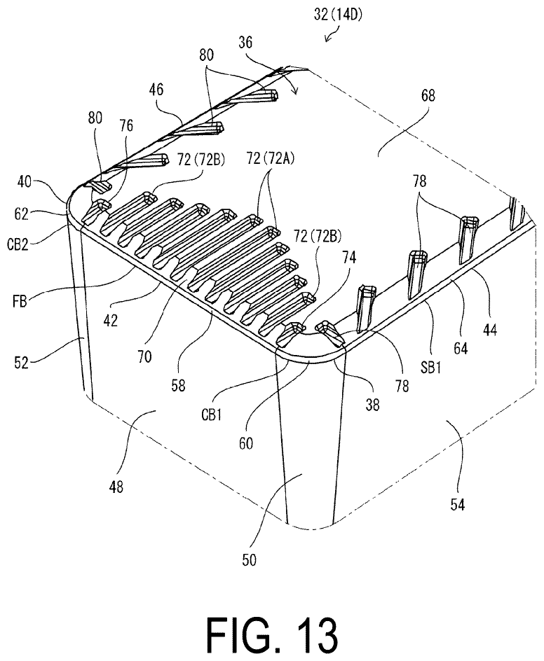

Fourth Variation of Embodiment A configuration of a cutting insert 14D according to a fourth variation of the embodiment of the present disclosure will be described with reference to FIG. 13. FIG. 13 is a schematic enlarged perspective view of a part of the cutting insert 14D according to the fourth variation of the embodiment of the present disclosure.

As in the example illustrated in FIG. 13, the cutting insert 14D according to the fourth variation of the embodiment of the present disclosure has the same configuration as that of the cutting insert 14C except for some parts. In the configuration of the cutting insert 14D, differences from the configuration of the cutting insert 14C will be described. For convenience of description, a member having the same function as that of a member described in the third variation of the embodiment is denoted by the same reference sign.

The upper surface 36 of the cutting portion 32 may include a plurality of first lateral grooves 78 extending inwardly with respect to the first lateral land surface 64. One first lateral groove 78 may extend inwardly with respect to the boundary between the first lateral land surface 64 and the first corner land surface 60.

The upper surface 36 of the cutting portion 32 may include a plurality of second lateral grooves 80 extending inwardly with respect to the second lateral land surface 66. One second lateral groove 80 may extend inwardly with respect to the boundary between the second lateral land surface 66 and the first corner land surface 60.

### Other Embodiments

As in the examples illustrated in FIGS. 3 to 13, the technical idea applied to the cutting tool 10 (10A, 10B, 10C, 10D) may be applied to a rotating tool used for milling.

### Method for Manufacturing Machined Product

A description will be given of a method for manufacturing a machined product according to an embodiment of the present disclosure with reference to FIGS. 14 to 16. FIGS. 14 to 16 are schematic views illustrating the method for manufacturing the machined product according to the embodiment.

As in the example illustrated in FIGS. 14 to 16, the method for manufacturing the machined product according to the embodiment is a method for manufacturing a machined product M which is the workpiece W after the machining, and includes a first step, a second step, and a third step. The first step is a step of rotating the workpiece W about its axis S. The second step is a step of bringing the cutting insert 14 of the cutting tool 10 into contact with the rotating workpiece W. The third step is a step of separating the cutting tool 10 from the workpiece W. Examples of the material of the workpiece W include stainless steel, carbon steel, alloy steel, cast iron, a non-ferrous metal, or the like. The specific content of the method for manufacturing the machined product according to the embodiment is as follows.

First, the cutting tool 10 is attached to a tool rest of a lathe, and the workpiece W is attached to a chuck of the lathe. Next, as in the example illustrated in FIG. 14, the chuck is rotated to rotate the workpiece W about its axis S (first step). As in the example illustrated in FIG. 15, the cutting tool 10 is moved in the direction of an arrow D1 to approach the workpiece W, whereby the cutting portion 32 of the cutting insert 14 is brought into contact with an outer peripheral surface Wf of the rotating workpiece W and a cut is made in the workpiece W (second step). Thus, machining of the workpiece W is performed, and a machined groove Wg can be formed on the outer peripheral surface Wf of the workpiece W.

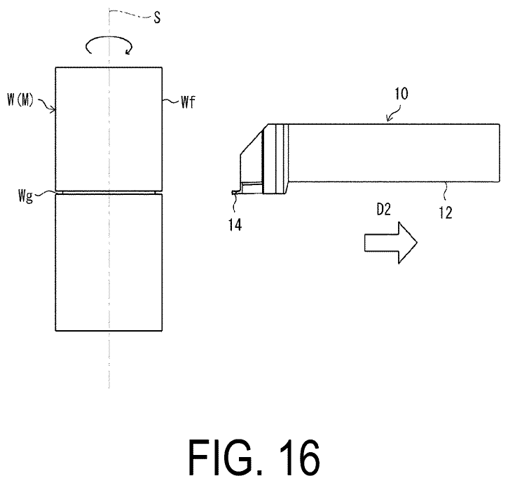

Then, as in the example illustrated in FIG. 16, the cutting tool 10 is moved away from the workpiece W by moving the cutting tool 10 in the direction of an arrow D2 (third step). This completes the machining of the workpiece W and allows a machined product M which is the workpiece W after the machining to be manufactured. Since the cutting insert 14 has excellent cutting capabilities because of the above reasons, the machined product M excellent in machining accuracy can be manufactured.

When the machining is continued, the cutting portion 32 of the cutting insert 14 may be repeatedly brought into contact with a different portion of the workpiece W may be repeated, while the workpiece W is rotated. Although the cutting tool 10 is brought close to the workpiece W in the embodiment of the present disclosure, the cutting tool 10 only needs to be brought relatively close to the workpiece W. Thus, for example, the workpiece W may be brought close to the cutting tool 10. In this respect, the same procedure is performed in separating the cutting tool 10 from the workpiece W.

In the present disclosure, the invention has been described above based on the drawings and examples. However, the invention according to the present disclosure is not limited to the above-described embodiments. That is, the embodiments of the invention according to the present disclosure can be modified in various ways within the scope illustrated in the present disclosure, and embodiments obtained by appropriately combining the technical means disclosed in different embodiments are also included in the technical scope of the invention according to the present disclosure. In other words, a person skilled in the art can easily make various variations or modifications based on the present disclosure. Note that these variations or modifications are included within the scope of the present disclosure.

For example, each of the front land surface 58, the first corner land surface 60, the second corner land surface 62, the first lateral land surface 64, and the second lateral land surface 66 may be a honing surface formed by so-called honing process. The rising wall surface 70 may be a land surface. In such a case, since the honing surface has a curved shape while the land surface has a planar shape, the honing surface and the land surface can be distinguished from each other.

1. A cutting insert, comprising:
an upper surface comprising a first corner, a second corner, and a first side connected to the first corner and the second corner;
a front side surface connected to the first side;
a first corner side surface connected to the first corner;
a front cutting edge located on the first side; and
a first corner cutting edge located at the first corner,
wherein
the upper surface further comprises
a front land surface extending along the front cutting edge,
a first corner land surface extending along the first corner cutting edge,
a front groove extending inwardly from the front land surface, and
a first corner groove extending inwardly from the first corner land surface, and
a length of the first corner groove is shorter than a length of the front groove.

2. The cutting insert according to claim 1, wherein
the first corner groove extends inwardly from a boundary between the front land surface and the first corner land surface.

3. The cutting insert according to claim 2, wherein
the first corner groove extends in parallel to the front groove.

4. The cutting insert according to claim 1, wherein
a width of the first corner groove is smaller than a width of the front groove.

5. The cutting insert according to claim 4, wherein
a depth of the first corner groove is the same as a depth of the front groove.

6. The cutting insert according to claim 1, wherein
the front groove comprises
a first front groove; and
a second front groove located closer to the first corner than the first front groove, and
a length of the first front groove is the same as a length of the second front groove.

7. The cutting insert according to claim 1, wherein
the front groove comprises
a first front groove; and
a second front groove located closer to the first corner than the first front groove, and
a length of the first front groove is longer than a length of the second front groove.

8. The cutting insert according to claim 1, further comprising
a second corner side surface connected to the second corner; and
a second corner cutting edge located at the second corner,
wherein
the upper surface further comprises
a second corner land surface extending along the second corner cutting edge; and
a second corner groove extending inwardly from the second corner land surface, and
a length of the second corner groove is shorter than a length of the front groove.

9. The cutting insert according to claim 1, wherein
the upper surface further comprises
a second side connected to the first corner; and
a lateral land surface extending along the second side; and
a lateral groove extending inwardly from the lateral land surface, and
a length of the lateral groove is longer than a length of the first corner groove.

10. The cutting insert according to claim 1, wherein
the front groove is separated from the front cutting edge, and
the first corner groove is separated from the first corner cutting edge.

11. A cutting tool comprising:
a holder having a rod shape extending from a first end to a second end, and comprising a pocket located at the first end; and
the cutting insert described in claim 1, the cutting insert being located in the pocket.

12. A method for manufacturing a machined product, the method comprising:
rotating a workpiece;
bringing the cutting tool described in claim 11 into contact with the workpiece being rotated; and
separating the cutting tool from the workpiece.
